(19) United States
(12) Patent Application Publication
(10) Pub. No.: US 2012/0114057 A1
(43) Pub. Date: May 10, 2012

(54) WIRELESS COMMUNICATION DEVICE, WIRELESS COMMUNICATION SYSTEM AND INFORMATION NOTIFYING METHOD

(75) Inventors: Hiroshi NAKATAKE, Nagoya-shi (JP); Hiroaki Goto, Nagoya-shi (JP); Nagahiro Matsuura, Nagoya-shi (JP)

(73) Assignee: Buffalo Inc., Nagoya-shi (JP)

(21) Appl. No.: 13/288,310

(22) Filed: Nov. 3, 2011

(30) Foreign Application Priority Data
Nov. 5, 2010 (JP) 2010-248057

(51) Int. Cl. H04B 7/02

(52) U.S. Cl. 375/267

(57) ABSTRACT

A wireless communication device or an access point includes: a main unit; an external antenna unit; a throughput check module; and a notification controller, a notice applying circuit and a notice generating circuit. The main unit is for including a communication control circuit. The external antenna unit is for including an antenna and is electrically connected with the main unit via a cable. The throughput check module is for checking throughput of communication with another wireless communication device or a station. The notification controller, the notice applying circuit and the notice generating circuit are for notifying a user of system information based on check result by the throughput check module, by using the external antenna unit. This configuration improves the work efficiency of antenna adjustment at the wireless communication device using the external antenna unit.

### CROSS-REFERENCE TO RELATED APPLICATION

The present application claims the priority based on Japanese Patent Application No. 2010-248057 filed on Nov. 5, 2010, the disclosure of which is hereby incorporated by reference in its entirety.

### BACKGROUND

1. Technical Field

This invention relates to a wireless local area network (wireless LAN).

2. Related Art

Various techniques regarding an antenna of a wireless communication device have been known to improve the communication status of wireless communication in a wireless LAN. For example, an external antenna is electrically connected via a cable with a main unit having a communication control circuit and is configured to allow for adjustment of the location and the direction of the antenna.

Generally the location and the direction of the antenna are adjusted to heighten the level of the field intensity received by the antenna. Even at the high level of field intensity, however, there may be poor level of communication status. For example, in the radio wave environment where another wireless communication or noise is present in the frequency domain used by the wireless LAN or in the radio wave environment where communication signals are reflected relatively often by the influence of the building structure or any obstacle, the level of communication status is lowered even at the high level of field intensity.

Applying MIMO (Multi Input Multi Output) system to the wireless LAN is known to allow for the high-speed wireless communication of the wireless LAN. The MIMO system is the technique for the high-speed wireless communication that provides plural antennas at each of a sender-side wireless communication device and a receiver-side wireless communication device to send different data from the plural antennas on the sender side and receive different data simultaneously at the plural antennas on the receiver side. In the MIMO system, the receiver-side wireless communication device utilizes refractive waves, in addition to direct waves propagating to the plural antennas, as effective radio waves.

In the wireless communication by the MIMO system using the refractive waves in addition to the direct waves, the correlation between the field intensity and the communication status is especially lowered, so that trial-and-error antenna adjustment is actually made at the wireless communication device.

Consequently, there is a need to improve the work efficiency of antenna adjustment at a wireless communication device.

### SUMMARY

According to one aspect of the invention, there is provided a wireless communication device for making wireless communication by MIMO system with another wireless communication device. The wireless communication device comprises: a main unit comprising; an antenna unit; a throughput check module; and a notification module. The main unit is for including a communication control circuit. The communication control circuit is for controlling wireless communication with the another wireless communication device. The antenna unit is for including an antenna. The antenna unit is electrically connectable with the main unit. The antenna is for sending and receiving communication signal to and from the another wireless communication device. The throughput check module is for checking throughput of communication with the another wireless communication device. The notification module is for notifying a user of system information by using the antenna unit. The system information is based on check result by the throughput check module. This wireless communication device enables the user to make antenna adjustment based on the check result of the throughput by checking the system information notified by using the antenna unit. This results in improving the work efficiency of antenna adjustment.

In the wireless communication device, the system information may indicate at least one of a level of communication status with the another wireless communication device and a direction in which the antenna is to be pointed. This wireless communication device facilitates the user's making antenna adjustment based on the check result of the throughput.

In the wireless communication device, the main unit may be electrically connectable with the antenna unit via a coaxial cable, and the notification module may include: an applying circuit; a first DC cutoff circuit; a generating circuit; and a second DC cutoff circuit. The applying circuit is for applying DC power based on the system information to a first wiring to which the applying circuit is electrically connected. The first wiring is for making electrical connection between the communication control circuit and the coaxial cable. The first DC cutoff circuit is for cutting supply of DC power to the communication control circuit. The first DC cutoff circuit is provided between the communication control circuit and the applying circuit on the first wiring. The generating circuit is for generating at least one of light and sound according to DC power applied to a second wiring to which the generating circuit electrically connected. The second wiring is for making electrical connection between the coaxial cable and the antenna. The second DC cutoff circuit is for cutting supply of DC power to the antenna. The second DC cutoff circuit is provided between the generating circuit and the antenna on the second wiring. This wireless communication device can implement the notification module by relatively simple configuration.

In the wireless communication device, the throughput check module may include at least one of a measurement module and an obtaining module. The measurement module is for measuring throughput of communication with the another wireless communication device. The obtaining module is for obtaining measurement result of throughput measured at the another wireless communication device, from the another wireless communication device. This wireless communication device allows for checking the throughput of communication with the another wireless communication device, based on the measured values.

In the wireless communication device, the throughput check module may check the throughput with respect to plural directions of the antenna. And the notification module may notify the user of a direction in which the antenna is to be pointed, by using the antenna unit, based on the check result by the throughput check module. The user can thus be notified of a more desirable direction in which the antenna unit is to be pointed.

In the wireless communication device, the plural directions of the antenna unit may be directions of the antenna rotated by every preset angle plural times. And the notification module may notify the user of a rotating direction and a number of rotations to the direction in which the antenna is to be pointed, by using the antenna unit. This facilitates the user's setting the direction of the antenna in which the antenna is to be pointed to a more desirable direction.

In the wireless communication device, the throughput check module may check the throughput with respect to plural directions of the antenna and identify a direction of lowering the check result obtained by checking the throughput. And the notification module may notify the user of a direction different from the identified direction. This enables the user to avoid the direction of lowering the check result of the throughput when setting the direction of the antenna.

According to another aspect of the invention, there is provided a wireless communication system comprising a wireless access point and a wireless station. In the wireless communication system according to another aspect, at least one of the wireless access point and the wireless station is the wireless communication device including: a main unit; an antenna unit; a throughput check module; and a notification module. The main unit is for including a communication control circuit. The communication control circuit is for controlling wireless communication with the another wireless communication device. The antenna unit is for including an antenna. The antenna unit is electrically connectable with the main unit. The antenna is for sending and receiving communication signal to and from the another wireless communication device. The throughput check module is for checking throughput of communication with the another wireless communication device. The notification module is for notifying a user of system information by using the antenna unit. The system information is based on check result by the throughput check module. This wireless communication system can improve the work efficiency of antenna adjustment at the wireless access point or at the wireless station.

According to another aspect of the invention, there is provided an information notifying method of notifying a user of information by a wireless communication device for making wireless communication by MIMO system with another wireless communication device. The information notifying method according to another aspect comprises: checking throughput of communication with the another wireless communication device; and notifying the user of system information based on check result of the throughput, by using an antenna unit which is electrically connected via a cable with a main unit. The main unit is for including a communication control circuit for controlling wireless communication with the another wireless communication device. The antenna unit is for including an antenna for sending and receiving communication signal to and from the another wireless communication device. This information notifying method enables the user to make antenna adjustment based on the check result of the throughput by checking the system information notified by using the antenna unit. This results in improving the work efficiency of antenna adjustment. The information notifying method may be practiced in various embodiments like the wireless communication device described above and have advantageous effects similar to those of the wireless communication device.

The invention is not limited to the aspects of the wireless communication device, the wireless communication system and the information notifying method, but may be applied to various other aspects, for example, an external antenna unit for a wireless communication device, an antenna adjusting method and a program for causing the computer to perform antenna adjustment function. The invention is not restricted to the above aspects but may be practiced by various other aspects without departing from the scope of the invention.

### BRIEF DESCRIPTION OF THE DRAWINGS

FIG. 1 shows the configuration of a wireless communication system;

FIG. 2 shows an external antenna unit of an access point;

FIG. 3 shows the detailed structure of the access point;

FIG. 4 shows the detailed structure of a notice applying circuit and a notice generating circuit;

FIG. 5 shows the operating statuses of the notice applying circuit and the notice generating circuit;

FIG. 6 shows the detailed structure of a station;

FIG. 7 is a flowchart showing a communication status notifying process by the access point in the wireless communication system;

FIG. 8 is a flowchart showing a throughput check process by the access point and the station in the wireless communication system;

FIG. 9 is a flowchart showing a full range evaluation process by the access point according to a second embodiment;

FIG. 10 is a flowchart showing a particular range evaluation process by the access point according to a third embodiment; and

FIG. 11 is a flowchart showing a throughput check process by the access point and the station in the wireless communication system according to a fourth embodiment.

### DETAILED DESCRIPTION

In order to further clarify the configurations and the functions of the invention discussed above, wireless communication systems according to the invention are described below.

### A. First Embodiment

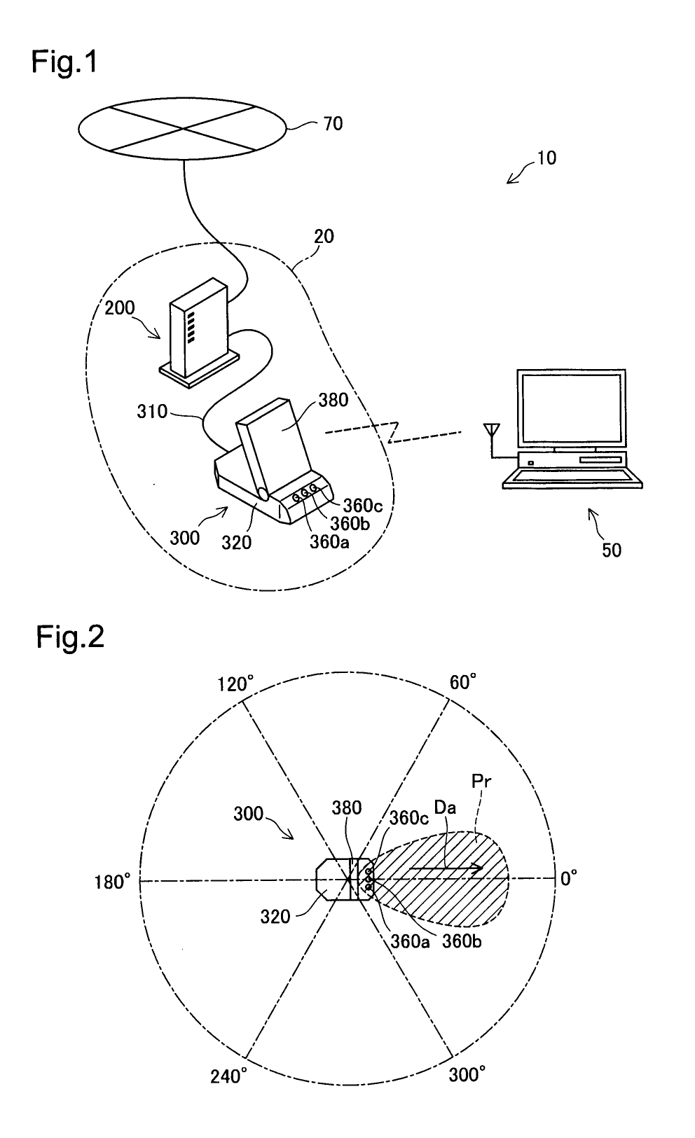

FIG. 1 shows the configuration of a wireless communication system 10. The wireless communication system 10 includes an access point 20 and a station 50. The access point 20 and the station 50 are wireless communication devices constituting a wireless LAN conforming to the IEEE802.11 standard. The access point 20 is also known as base station, and the station 50 is also known as terminal or client. Although only one station 50 is connected to the access point 20 in the illustrated example of FIG. 1, plural stations 50 may be connectable simultaneously. In this embodiment, the access point 20 and the station 50 mutually perform wireless communication by the MIMO system.

The access point 20 is capable of routing to further connect the station 50 via a wireless LAN to an external network 70, which is a different network from the wireless LAN created in the wireless communication system 10. The external network 70 is the Internet in this embodiment but may be another Wide Area Network (WAN) or a wired LAN conforming to the IEEE802.3 standard or another standard according to other embodiments.

The access point 20 of the wireless communication system 10 includes a main unit 200 and an external antenna unit 300 that are electrically connected with each other via a cable. The main unit 200 has a circuit to control wireless communication with the station 50. The external antenna unit 300 is an antenna unit including an antenna 380 to send and receive communication signals to and from the station 50. In this embodiment, the cable 310 is a coaxial cable.

The external antenna unit 300 of the access point 20 includes a support base 320 to support the antenna 380 and three light-emitting elements 360a, 360b and 360c to emit light, in addition to the antenna 380. The three light-emitting elements 360a, 360b and 360c constitute part of a notification module to notify the user of the wireless communication system 10 of system information.

FIG. 2 shows the external antenna unit 300 of the access point 20. The external antenna unit 300 illustrated in FIG. 2 is viewed from above in the direction of gravity. The antenna 380 of the external antenna unit 300 is a directional antenna to focus RF (high frequency) energy of communication signals used for wireless communication on a particular direction, and has a radiation pattern Pr in geometry extended in an oriented direction Da. The support base 320 of the external antenna unit 300 supports the antenna 380 to adjust the oriented direction Da of the antenna 380 to the horizontal direction. In this embodiment, the oriented direction Da of the antenna 380 may alternatively be adjusted to the vertical direction by adjusting the mounting angle of the antenna 380 to the support base 320.

In this embodiment, the three light-emitting elements 360a, 360b and 360c of the external antenna unit 300 are aligned in the horizontal direction, such that the light-emitting element 360a is located on the right, the light-emitting element 360b on the center, and the light-emitting element 360c on the left. The three light-emitting elements 360a, 360b and 360c are provided on the support base 320 in this embodiment but may be provided on the antenna 380 according to another embodiment. Although the three light-emitting elements 360a, 360b and 360c are light-emitting diodes (LEDs) in this embodiment, another light source such as electroluminescence may be used for the light-emitting elements 360a, 360b and 360c. In the description hereafter, the light-emitting element 360a, the light-emitting element 360b and the light-emitting element 360c are also referred to as “right LED”, “center LED” and “left LED”, respectively.

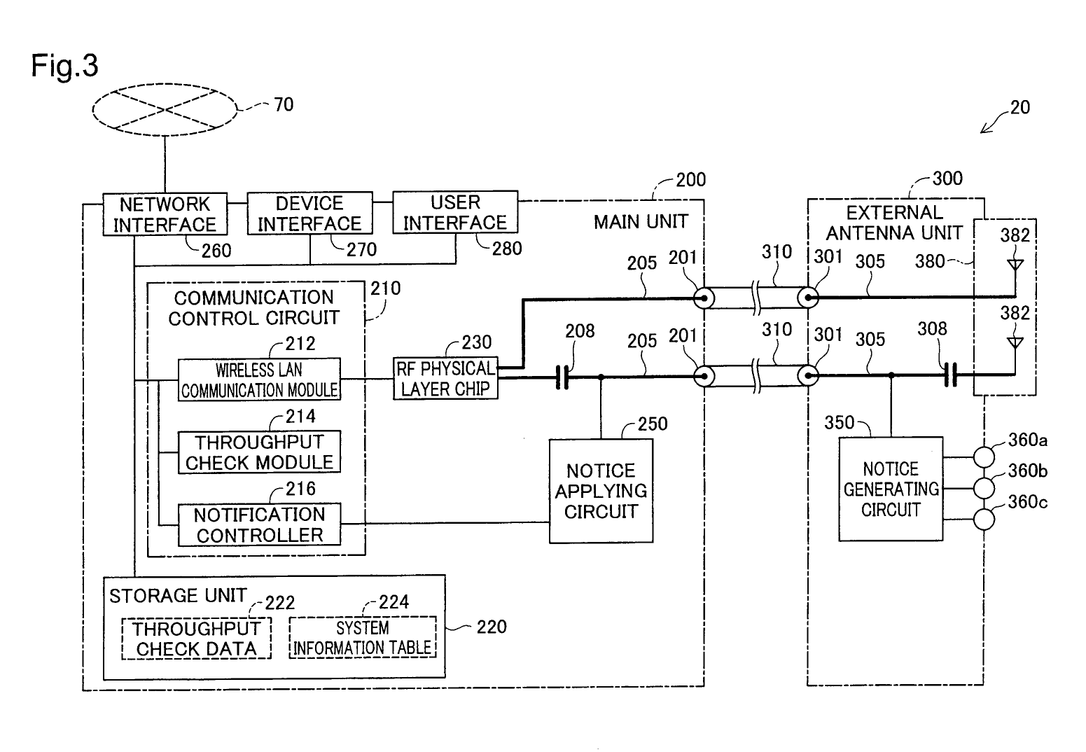

FIG. 3 shows the detailed structure of the access point 20. The access point 20 includes a communication control circuit 210, a storage unit 220, an RF physical layer chip 230, a notice applying circuit 250, a network interface 260, a device interface 270 and a user interface 280 in the main unit 200. The access point 20 includes a notice generating circuit 350 in addition to the antenna 380 in the external antenna unit 300.

The network interface 260 of the access point 20 exchanges data with the external network 70. The device interface 270 of the access point 20 is an interface to locally connect a device, such as a personal computer or an external storage unit, to the access point 20 and allow for direct data transfer. The device interface 270 is an interface complying with the USB (Universal Serial Bus) standard in this embodiment but may be another interface, for example, that complying with the SAS (Serial Attached SCSI) standard. The user interface 280 of the access point 20 includes input buttons to receive the user's inputs and display lamps to display the operating status of the access point 20.

The RF physical layer chip 230 of the access point 20 is an electric circuit to allow for interconversion between high frequency (RF) signals of communication signals sent from and received at the antenna 380 and digital signals available to the communication control circuit 210.

The antenna 380 of the access point 20 has plural antenna structures 382 to allow for wireless communication of the MIMO system. The corresponding number of cables 310 to the number of antenna structures 382 are provided to connect between the main unit 200 and the external antenna unit 300. In this embodiment, the access point 20 has two sets of antenna structures 382 and cables 310. In the access point 20, respective ends of each cable 310 are connected with each connector 201 of the main unit 200 and with each connector 301 of the external antenna unit 300. The respective connectors 201 of the main unit 200 are electrically connected with the RF physical layer chip 230 via respective first wirings 205. The respective connectors 301 of the external antenna unit 300 are electrically connected with the respective antenna structures 382 via respective second wirings 305.

The communication control circuit 210 of the access point 20 controls the respective parts of the access point 20. The communication control circuit 210 includes a wireless LAN communication module 212, a throughput check module 214 and a notification controller 216. In this embodiment, the functions of the wireless LAN communication module 212, the throughput check module 214 and the notification controller 216 of the communication control circuit 210 are implemented by the CPU (Central Processing Unit) of the communication control circuit 210 operated according to a program. According to another embodiment, at least part of the functions of the communication control circuit 210 may be implemented by the physical circuit structure of the communication control circuit 210.

The wireless LAN communication module 212 of the communication control circuit 210 is known as Media Access Controller (MAC) and is electrically connected with the RF physical layer chip 230. The wireless LAN communication module 212 controls wireless communication with the station 50 according to the IEEE802.11 standard, so as to create a wireless LAN conforming to the IEEE802.11 standard.

The throughput check module 214 of the communication control circuit 210 checks the throughput of communication with the station 50. In this embodiment, the throughput check module 214 obtains the throughput measured by the station 50 from the station 50 and thereby checks the throughput of communication with the station 50. The details of the operation by the throughput check module 214 will be described later.

The notification controller 216 of the communication control circuit 210 constitutes part of the notification module to notify the user of the wireless communication system 10 of system information. The notification controller 216 controls notification of system information to the user using the external antenna unit 300, based on the check result by the throughput check module 214. More specifically, the notification controller 216 outputs electric signals to the notice applying circuit 250 to control the light emissions of the three light-emitting elements 360a, 360b and 360c of the external antenna unit 300 and thereby control notification of the system information. The details of the operation by the notification controller 216 will be described later.

The storage unit 220 of the access point 20 stores various data available to the communication control circuit 210. The data stored in the storage unit 220 includes throughput check data 222 and a system information table 224. The throughput check data 222 is created by the throughput check module 214 and shows the check result of the throughput by the throughput check module 214. The system information table 224 is created by the notification controller 216 and stores system information based on the check result by the throughput check module 214.

The notice applying circuit 250 of the access point 20 is an electric circuit to turn on the three light-emitting elements 360a, 360b and 360c. The notice applying circuit 250 constitutes an applying circuit as part of the notification module to notify the user of the wireless communication system 10 of the system information. The notice applying circuit 250 is connected with one of the first wirings 205 and with the communication control circuit 210. The notice applying circuit 250 applies DC power corresponding to an electric signal output from the notification controller 216 of the communication control circuit 210, to the first wiring 205. A capacitor 208 is provided between the RF physical layer chip 230 and the notice applying circuit 250 on the first wiring 205, to which the notice applying circuit 250 is connected. The capacitor 208 is the first DC cutoff circuit to cut the supply of DC power to the RF physical layer chip 230.

The notice generating circuit 350 of the access point 20 is an electric circuit to turn on the three light-emitting elements 360a, 360b and 360c. The notice generating circuit 350 constitutes a generating circuit as part of the notification module to notify the user of the wireless communication system 10 of the system information. The notice generating circuit 350 is connected to the second wiring 305, which is electrically connected with the notice applying circuit 250 via the cable 310 and the first wiring 205. The notice generating circuit 350 causes the three light-emitting elements 360a, 360b and 360c to emit light according to the DC power applied to the second wiring 305 by the notice applying circuit 250 via the first wiring 205 and the cable 310. A capacitor 308 is provided between the notice generating circuit 350 and the antenna structure 382 on the second wiring 305, to which the notice generating circuit 350 is connected. The capacitor 308 is the second DC cutoff circuit to cut the supply of DC power to the antenna structure 382.

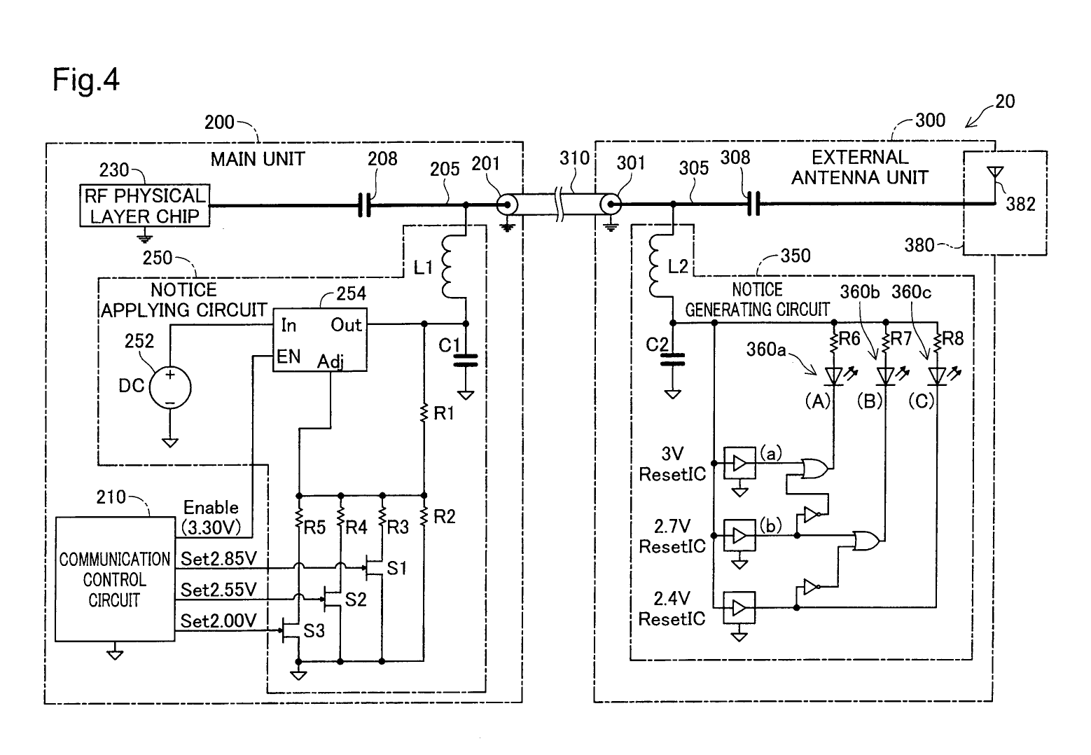

FIG. 4 shows the detailed structure of the notice applying circuit 250 and the notice generating circuit 350. The communication control circuit 210 has four output terminals “Enable”, “Set 2.85 V”, “Set 2.55 V” and “Set 2.00 V” to output high-level and low-level digital signals in response to an instruction of the notification controller 216. The digital signals output from these four output terminals are input into the notice applying circuit 250.

The notice applying circuit 250 includes a DC power source 252, an adjustable voltage regulator 254, an inductor L1, a capacitor C1, five resistors R1, R2, R3, R4 and R5 and three FETs (Field Effect Transistors) S1, S2 and S3. The output terminal “Enable” of the notification control circuit 210 is connected with the adjustable voltage regulator 254, the output terminal “Set 2.85 V” with the FET_S1, the output terminal “Set 2.55 V” with the FET_S2 and the output terminal “Set 2.00 V” with the FET_S3. Each of the FET_S1, FET_S2 and FET_S3 establishes electrical continuity in response to input of a high-level signal, whilst breaking electrical continuity in response to input of a low-level signal.

The DC power source 252 of the notice applying circuit 250 generates DC power. The adjustable voltage regulator 254 of the notice applying circuit 250 varies the voltage level of the DC power generated by the DC power source 252. The adjustable voltage regulator 254 has terminals “EN”, “In”, “Out” and “Adj”. The adjustable voltage regulator 254 changes the DC power received at the terminal “In” to a voltage corresponding to the input voltage received at the terminal “Adj” to output the changed voltage from the terminal “Out”. The output terminal “Enable” of the communication control circuit 210 is connected with the terminal “EN” of the adjustable voltage regulator 254. The adjustable voltage regulator 254 disables the voltage adjustment at a high level of the terminal “EN” and enables the voltage adjustment at a low level.

The terminal “Out” of the adjustable voltage regulator 254 is connected with the first wiring 205 via the inductor L1, while being grounded via the capacitor C1. Additionally, the terminal “Out” of the adjustable voltage regulator 254 is grounded via the electrical paths connected in series in the order of the resistors R1 and R2.

The terminal “Adj” of the adjustable voltage regulator 254 is grounded via the four resistors R2, R3, R4 and R5 connected in parallel. The FET_S1 is provided on the electrical path of the resistor R3, the FET_S2 is provided on the electrical path of the resistor R4 and the FET_S3 is provided on the electrical path of the resistor R5.

The notice generating circuit 350 includes three reset ICs (Integrated Circuits) “3 V”, “2.7 V” and “2.4 V”, an inductor L2, a capacitor C2 and three resistors R6, R7 and R8. Each of the reset ICs “3 V”, “2.7 V” and “2.4 V” outputs a high-level signal at the input voltage of not lower than a reference voltage, while outputting a low-level signal at the input voltage of lower than the reference voltage. The reference voltage of the reset IC “3 V” is 3.00 volts, the reference voltage of the reset IC “2.7 V” is 2.70 volts and the reference voltage of the reset IC “2.4 V” is 2.40 volts.

Each of the reset ICs “3 V”, “2.7 V” and “2.4 V” of the notice generating circuit 350 receives the input voltage of the DC power applied to the second wiring 305 via the inductor L2. The inductor L2 connecting with the second wiring 305 is connected with the reset ICs “3 V”, “2.7 V” and “2.4 V”, while being grounded via the capacitor C2 and being connected with the respective anodes of the three light-emitting elements 360a, 360b and 360c via the resistors R6, R7 and R8. The respective cathodes of the three light-emitting elements 360a, 360b and 360c are connected with the outputs of the reset ICs “3 V”, “2.7 V” and “2.4 V” via logic circuits.

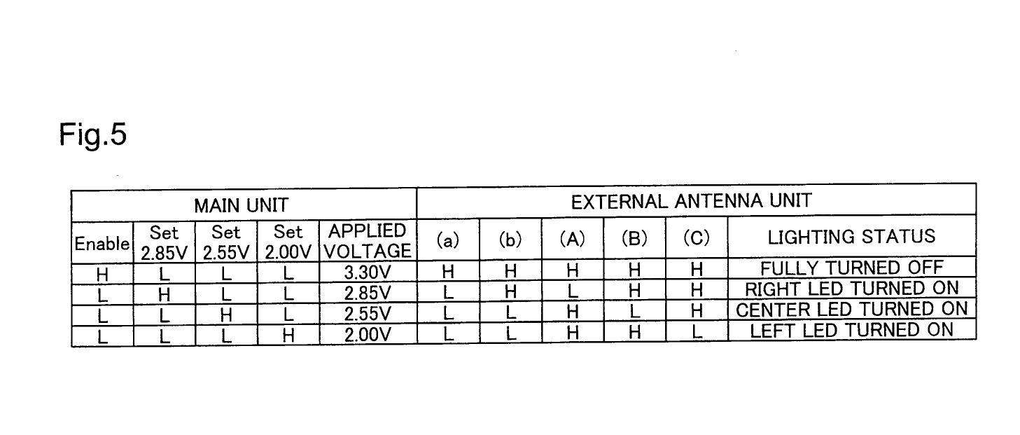

FIG. 5 shows the operating statuses of the notice applying circuit 250 and the notice generating circuit 350. In the table of FIG. 5, “H” and “L” respectively represent the high-level signal and the low-level signal. FIG. 5 shows the signal statuses of the four output terminals “Enable”, “Set 2.85 V”, “Set 2.55 V” and “Set 2.00 V” and the applied voltage of the DC power applied by the notice applying circuit 250 to the first wiring 205 as the conditions of the main unit 200. FIG. 5 shows the signal statuses of the respective electrical paths in the notice generating circuit 350 and the lighting statuses of the three light-emitting elements 360a, 360b and 360c as the conditions of the external antenna unit 300.

The electrical path (a) of the notice generating circuit 350 is an electrical path at the output of the reset IC “3 V”. The electrical path (b) of the notice generating circuit 350 is an electrical path at the output of the reset IC “2.7 V”. The electrical path (A) of the notice generating circuit 350 is an electrical path at the cathode of the light-emitting element 360a. The electrical path (B) of the notice generating circuit 350 is an electrical path at the cathode of the light-emitting element 360b. The electrical path (C) of the notice generating circuit 350 is an electrical path at the cathode of the light-emitting element 360c.

In the main unit 200, when the output terminal “Enable” is at high level and the other output terminals “Set 2.85 V”, “Set 2.55 V” and “Set 2.00 V” are at low levels, the applied voltage by the notice applying circuit 250 is equal to “3.30 volts”. In this case, the electrical paths (a), (b), (A), (B) and (C) of the notice generating circuit 350 are all at high level, so that the lighting status is “Fully Turned OFF”, wherein all the three light⁻emitting elements 360a, 360b and 360c are turned off.

In the main unit 200, when the output terminal “Set 2.85 V” is at high level and the other output terminals “Enable”, “Set 2.55 V” and “Set 2.00 V” are at low level, the applied voltage by the notice applying circuit 250 is “2.85 volts”. In this case, the electrical paths (b), (B) and (C) of the notice generating circuit 350 are at high level, while the other electrical paths (a) and (A) are at low level, so that the lighting status is “Right LED Turned ON”, wherein only the light-emitting element 360a of the three light-emitting elements 360a, 360b and 360c is turned on.

In the main unit 200, when the output terminal “Set 2.55 V” is at high level and the other output terminals “Enable”, “Set 2.85 V” and “Set 2.00 V” are at low level, the applied voltage by the notice applying circuit 250 is “2.55 volts”. In this case, the electrical paths (A) and (C) of the notice generating circuit 350 are at high level, while the other electrical paths (a), (b) and (B) are at low level, so that the lighting status is “Center LED Turned ON”, wherein only the light-emitting element 360b of the three light-emitting elements 360a, 360b and 360c is turned on.

In the main unit 200, when the output terminal “Set 2.00 V” is at high level and the other output terminals “Enable”, “Set 2.85 V” and “Set 2.55 V” are at low level, the applied voltage by the notice applying circuit 250 is “2.00 volts”. In this case, the electrical paths (A) and (B) of the notice generating circuit 350 are at high level, while the other electrical paths (a), (b) and (C) are at low level, so that the lighting status is “Left LED Turned ON”, wherein only the light-emitting element 360c of the three light-emitting elements 360a, 360b and 360c is turned on.

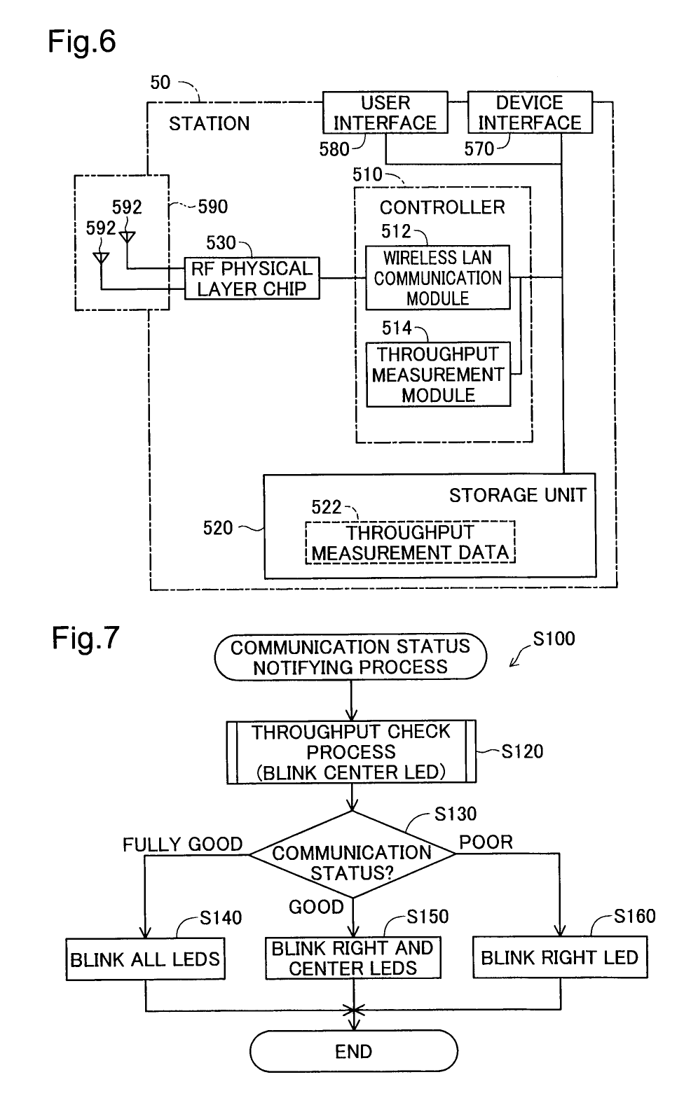

FIG. 6 shows the detailed structure of the station 50. The station 50 includes a controller 510, a storage unit 520, an RF physical layer chip 530, a device interface 570, a user interface 580 and an antenna 590.

The device interface 570 of the station 50 directly exchanges data with an external device and includes an interface complying with the USB standard in this embodiment. The user interface 580 of the station 50 includes a keyboard to receive the user's input of information and a monitor to output information to the user.

The RF physical layer chip 530 of the station 50 is an electric circuit to allow for interconversion between high frequency (RF) signals of communication signals sent from and received at the antenna 590 and digital signals available to the controller 510.

The antenna 590 of the station 50 has plural antenna structures 592 to allow for wireless communication of the MIMO system. In this embodiment, the station 50 has the two antenna structures 592 in the antenna 590 corresponding to the number of the antenna structures 382 in the access point 20. The number of the antenna structures 592 in the station 50 may, however, not be necessarily equal to the number of the antenna structures 382 in the access point 20. When the access point 20 and the station 50 have different numbers of antenna structures, the signal transmission and reception is performed according to the less number of antenna structures.

The controller 510 of the station 50 controls the respective parts of the station 50. The controller 510 includes a wireless LAN communication module 512 and a throughput measurement module 514. The functions of the wireless LAN communication module 512 and the throughput measurement module 514 of the controller 510 are implemented by the CPU of the controller 510 operated according to a program in this embodiment. At least part of the functions of the controller 510 may be implemented by the physical circuit structure of the controller 510 according to another embodiment.

The wireless LAN communication module 512 of the controller 510 is also known as Media Access Controller and is electrically connected with the RF physical layer chip 530. The wireless LAN communication module 512 controls wireless communication to the access point 20, so as to make connection to the wireless LAN created by the access point 20.

The throughput measurement module 514 of the controller 510 measures the throughput of communication with the access point 20. In this embodiment, the throughput measurement module 514 provides the access point 20 with the measurement result of the throughput. The details of the operation by the throughput measurement module 514 will be described later.

The storage module 520 of the station 50 stores various data available to the controller 510. The data stored in the storage unit 520 includes throughput measurement data 522. The throughput measurement data 522 is created by the throughput measurement module 514. The throughput measurement data 522 shows the measurement result of the throughput by the throughput measurement module 514.

FIG. 7 is a flowchart showing a communication status notifying process (step S100) performed by the access point 20 in the wireless communication system 10. The communication status notifying process (step S100) notifies the user of the system information showing the good or poor communication status at the current location and direction of the external antenna unit 300, by using the external antenna unit 300. In this embodiment, the communication control circuit 210 of the access point 20 starts the communication status notifying process (step S100), in response to the user's command input received by the user interface 280.

On the start of the communication status notifying process (step S100), the communication control circuit 210 of the access point 20 serving as the throughput check module 214 performs throughput check process (step S120). In the throughput check process (step S120), the communication control circuit 210 checks the throughput of communication with the station 50 and writes the throughput check data 222 showing the check result into the storage unit 220. In this embodiment, in order to notify the user of the throughput check process (step S120) in progress, the communication control circuit 210 serving as the notification controller 216 blinks the light-emitting element 360b or the center LED. The details of the throughput check process (step S120) will be described later.

After the throughput check process (step S120), the communication control circuit 210 serving as the notification controller 216 detects the level of communication status (step S130). More specifically, the communication control circuit 210 detects the level of communication status based on the throughput check data 222 stored in the storage unit 220 and stores the detection result as the system information into the system information table 224 of the storage unit 220. The notification controller 216 detects the level of communication status at three grades “fully good”, “good” and “poor” in this embodiment. The notification controller 216 may detect the level of communication status at two grades “good” and “poor” or at four or more grades according to other embodiments. In this embodiment, the system information showing one of the three grades “fully good”, “good” and “poor” is stored in the system information table 224 of the storage unit 220.

After detecting the level of communication status (step S130), the communication control circuit 210 serving as the notification controller 216 notifies the user of the system information based on the check result by the throughput check process (step S120) by using the external antenna unit 300 (step S140, S150 or S160). In this embodiment, the communication control circuit 210 blinks the three light-emitting elements 360a, 360b and 360c or all the LEDs (step S140) when the system information stored in the system information table 224 of the storage unit 220 shows “fully good”. The communication control circuit 210 blinks the two light-emitting elements 360a and 360b or the right LED and the center LED (step S150) when the system information shows “good”. The communication control circuit 210 blinks only the light-emitting element 360a or the right LED (step S160) when the system information shows “poor. After notifying the system information (step S140, S150 or S160), the communication control circuit 210 concludes the communication status notifying process (step S100).

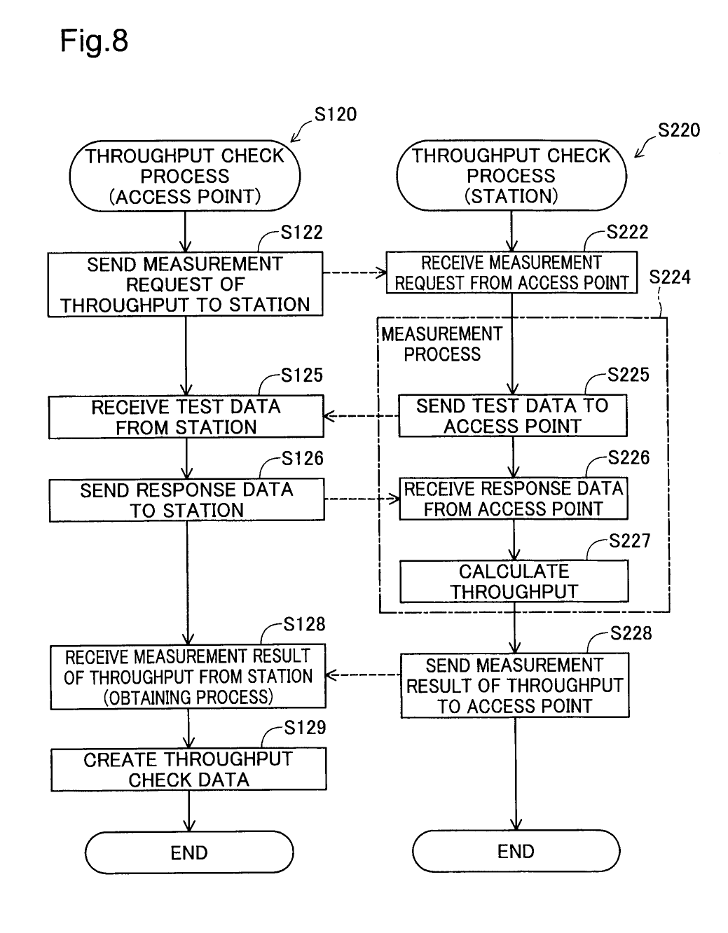

FIG. 8 is a flowchart showing the throughput check process (steps S120 and S220) performed by the access point 20 and the station 50 in the wireless communication system 10. The throughput check process (steps S120 and S220) is series of processing to check the throughput of communication between the access point 20 and the station 50.

On the start of the throughput check process (step S120), the communication control circuit 210 of the access point 20 sends a measurement request of the throughput to the station 50 (step S122).

The controller 510 of the station 50 starts the throughput check process (step S220), in response to the measurement request from the access point 20. When receiving the measurement request from the access point 20 (step S222), the controller 510 of the station 50 serving as the throughput measurement module 514 performs measurement process (step S224). In the measurement process (step S224), the controller 510 measures the throughput of communication with the access point 20 and writes the throughput measurement data showing the measurement result into the storage unit 520.

More specifically, in the measurement process (step S224), the controller 510 transmits test data to the access point 20 by wireless communication using the antenna 590 (step S225) and receives response data from the access point 20 responding to the data transmission (step S226). The controller 510 then measures the throughput of communication with the access point 20, based on the time required between transmission of the test data and reception of the response data and the data volume of the test data. In the measurement process (step S224) of this embodiment, the controller 510 measures the throughput plural times and calculates the mean value of the plural measurements as the measurement result of the throughput (step S227). The controller 510 utilizes Echo message as the test data of the measurement process (step S224) in this embodiment, but may utilize any other data set in advance with the access point 20 according to another embodiment.

While the station 50 is performing the measurement process (step S224), the communication control circuit 210 of the access point 20 receives the test data from the station 50 by wireless communication using the antenna 380 (step S125) and sends the response data, i.e., the received Echo message in this embodiment, to the station 50 (step S126).

After the measurement process (step S224), the controller 510 of the station 50 sends the measurement result of the throughput shown by the throughput measurement data 522 in the storage unit 520 to the access point 20 (step S228). The controller 510 of the station 50 then terminates the throughput check process (step S220).

The communication control circuit 210 of the access point 20 serving as the obtaining module as one function of the throughput check module 214 performs obtaining process (step S128) to receive the measurement result of the throughput from the station 50. After the obtaining process (step S128), the communication control circuit 210 creates the throughput check data 222 based on the measurement result received from the station 50 and writes the created throughput check data 222 into the storage unit 220 (step S129). The communication control circuit 210 of the access point 20 then terminates the throughput check process (step S120).

In the wireless communication system 10 of the first embodiment described above, the user can make antenna adjustment of the access point 20 based on the check result of the throughput by checking the system information notified by using the external antenna unit 300 of the access point 20. This results in allowing for antenna adjustment of the access point 20 using only the external antenna unit 300, thus improving the work efficiency of antenna adjustment of the access point 20.

Additionally, the access point 20 notifies the user of the system information showing the level of communication status with the station 50, by using the external antenna unit 300, so that the user can readily make antenna adjustment of the access point 20 based on the check result of the throughput.

Furthermore, the access point 20 causes the main unit 200 to perform the notification using the external antenna unit 300 via the cable 310. More specifically, in the access point 20, the notice generating circuit 350 of the external antenna unit 300 turns on the three light-emitting elements 360a, 360b and 360c according to the DC power applied to the cable 310 by the notice applying circuit 250 of the main unit 200, so that the notification using the external antenna unit 300 can be implemented by the relatively simple configuration.

Additionally, the access point 20 performs the obtaining process (step S128) to obtain the measurement result of the throughput, which is measured in the station 50, from the station 50, so that the throughput of communication with the station 50 can be checked based on the measured values.

### B. Second Embodiment

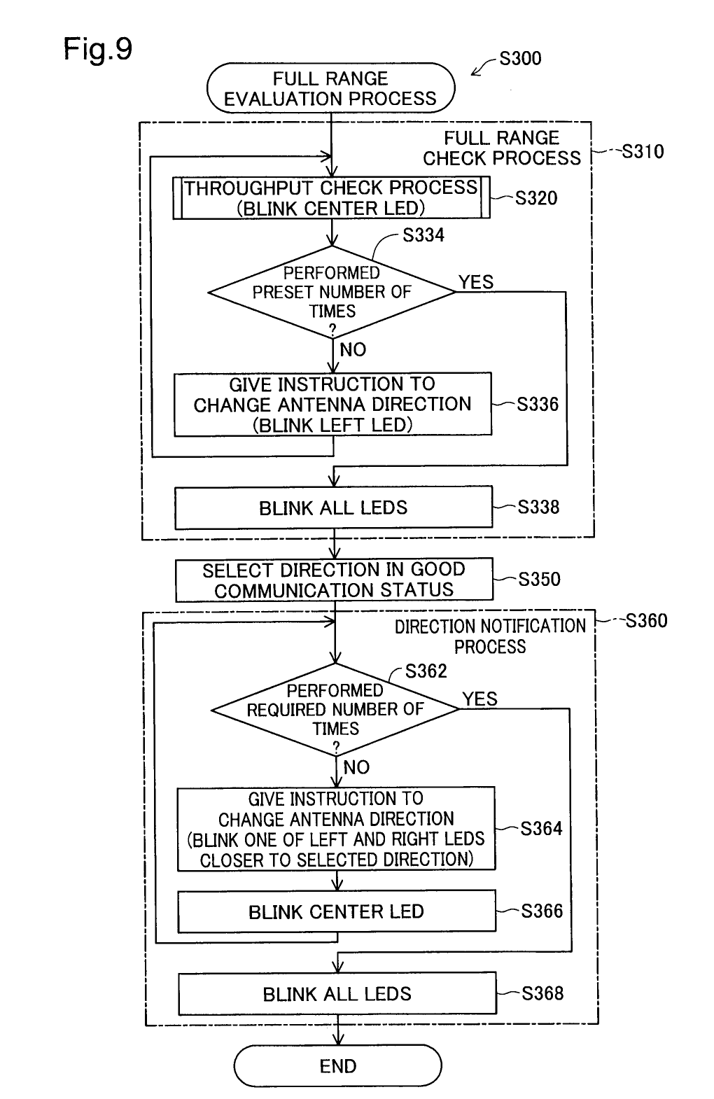

FIG. 9 is a flowchart showing a full range evaluation process (step S300) performed by the access point 20 according to a second embodiment. The wireless communication system 10 of the second embodiment is similar to that of the first embodiment, except the full range evaluation process (step S300) performed by the access point 20. The full range evaluation process (step S300) is series of processing to check the communication status at each direction in which the antenna 380 is pointed over the full range in the horizontal direction and notify the user of system information, which shows the direction in which the antenna 380 is to be pointed, by using the external antenna unit 300. In this embodiment, the communication control circuit 210 of the access point 20 starts the full range evaluation process (step S300), in response to the user's command input received by the user interface 280.

On the start of the full range evaluation process (step S300), the communication control circuit 210 of the access point 20 performs full range check process (step S310). The full range check process (step S310) is processing to check the communication status at each direction in which the antenna 380 is pointed over the full range in the horizontal direction. In this embodiment, the direction in which the antenna 380 is pointed in the horizontal direction at the start of the full range check process (step S310) is set to “0”. Then the communication status is checked at the respective directions rotated by every 60 degrees counterclockwise viewed from above in the direction of gravity. More specifically, the full range check process (step S310) of this embodiment checks the communication status at six directions “0°”, “60°”, “120°”, “180°”, “240°” and “300°”. According to other embodiments, the communication status may be checked at a less number of directions than six by setting the rotation angle to be greater than 60 degrees. Otherwise the communication status may be checked at a greater number of directions than six by setting the rotation angle to be less than 60 degrees. The user manually changes the direction in which the antenna 380 is pointed in this embodiment. According to another embodiment, a motor for changing the direction of the antenna 380 may be connected to the antenna 380 and may be driven to change the direction in which the antenna 380 is pointed by preset rotation angles.

In the full range check process (step S310), the communication control circuit 210 serving as the throughput check module 214 performs throughput check process (step S320). In the throughput check process (step S320), the communication control circuit 210 checks the throughput of communication with the station 50 and writes the throughput check data 222 showing the check result into the storage unit 220. The details of the throughput check process (step S320) are identical with those of the throughput check process (step S120) of the first embodiment, wherein each cycle of the throughput check process (step S320) performs checking the throughput plural times and adopts the mean value of the plural checks as the check result.

After the throughput check process (step S320), the communication control circuit 210 checks whether the throughput check process (step S320) has been performed a preset number of times (step S334). In this embodiment, since the communication status is to be checked at six different directions, it is checked whether the throughput check process (step S320) has been performed six times.

When the throughput check process (step S320) has not yet been performed the preset number of times (step S334: No), the communication control circuit 210 serving as the notification controller 216 blinks the light-emitting element 360c or the left LED and thereby gives the user instruction to rotate the direction of the antenna 380 counterclockwise by one step (60 degrees in this embodiment) (step S336). After giving the user instruction to change the direction of the antenna 380 (step S336), the communication control circuit 210 repeats the series of processing from the throughput check process (step S320).

When the throughput check process (step S320) has been performed the preset number of times (step S334: Yes), the communication control circuit 210 serving as the notification controller 216 notifies the user of completion of checking the throughput over the full range in the horizontal direction by using the external antenna unit 300 (step S338). More specifically, the communication control circuit 210 blinks the three light-emitting elements 360a, 360b and 360c or all the LEDs to notify the user of completion of checking the throughput in this embodiment. After notification of the completion of checking the throughput (step S338), the communication control circuit 210 terminates the full range check process (step S310).

After the full range check process (step S310), the communication control circuit 210 serving as the notification controller 216 selects the direction in which the antenna 380 is to be pointed (step S350). More specifically, the communication control circuit 210 refers to the throughput check data 222 stored in the storage unit 220, selects the direction having the highest level of communication status, and stores the selection result as system information into the system information table 224 in the storage unit 220. In this embodiment, the communication control circuit 210 selects one of the six directions “0°”, “60°”, “120°”, “180°”, “240°” and “300°” and stores the selected one (for example, 120°)of the six directions into the system information table 224 in the storage unit 220. Alternatively the level of communication status at each direction may be stored in the system information table 224. The level of communication status herein may be expressed by the throughput obtained by the throughput checking or may be expressed by an index showing an ascending order or a descending order of the throughputs obtained by the throughput checking.

After selecting the direction in which the antenna 380 is to be pointed (step S350), the communication control circuit 210 serving as the notification controller 216 performs direction notification process (step S360) to notify the user of system information showing the direction in which the antenna 380 is to be pointed, by using the external antenna unit 300. In this embodiment, the direction notification process (step S360) notifies the user of system information showing the direction of rotation and the number of steps to rotate the direction of the antenna 380 from the direction at the end time of the full range check process (step S310) to the selected direction in which the antenna 380 is to be pointed, by using the external antenna unit 300.

For example, when the direction at the end time of the full range check process (step S310) is “300°” and the selected direction in which the antenna 380 is to be pointed is “60°”, in order to notify the user of rotating the direction of antenna 380 counterclockwise by two steps (120°), the direction notification process (step S360) blinks the light-emitting element 360c (left LED) twice with blinking the light-emitting element 360b (center LED) in between. In another example, when the direction at the end time of the full range check process (step S310) is “300°” and the selected direction in which the antenna 380 is to be pointed is “180°”, in order to notify the user of rotating the direction of antenna 380 clockwise by two steps (120°), the direction notification process (step S360) blinks the light-emitting element 360a (right LED) twice with blinking the light-emitting element 360b (center LED) in between.

When it is required to rotate the direction of antenna 380 by three steps (180°), for example, when the direction at the end time of the full range check process (step S310) is “300°” and the selected direction in which the antenna 380 is to be pointed is “120°”, the direction notification process (step S360) blinks either one of the light-emitting element 360a (right LED) and the light-emitting element 360c (left LED) three times with blinking the light-emitting element 360b (center LED) in between. This means that either the light-emitting element 360a or the light-emitting element 360c is blinked corresponding to the number of steps to be rotated.

When it is not required to rotate the direction of antenna 380, for example, for example, when the direction at the end time of the full range check process (step S310) is “300°” and the selected direction in which the antenna 380 is to be pointed is “300°”, the direction notification process (step S360) blinks only the light-emitting element 360b (center LED) without blinking one of the light-emitting element 360a (right LED) and the light-emitting element 360c (left LED).

In the direction notification process (step S360), the communication control circuit 210 serving as the notification controller 216 blinks one of the light-emitting element 360a (right LED) and the light-emitting element 360c (left LED) corresponding to the direction in which the antenna 380 is to be rotated and thereby gives instruction to change the direction of the antenna 380 (step S364). The communication control circuit 210 then blinks the light-emitting element 360b or the center LED (step S366). The communication control circuit 210 repeats the series of processing to give instruction on changing the antenna direction (steps S364 and S366) until the instruction on changing the antenna direction has been given a required number of times to make the antenna 380 pointed in the selected direction (step S362: No).

When the instruction on changing the antenna direction has been given (step S364) the required number of times (step S362: Yes), the communication control circuit 210 blinks the three light-emitting elements 360a, 360b and 360c or all the LEDs to notify the user of completion of notification of the selected direction (step S368). When it is not required to change the direction of the antenna 380, the communication control circuit 210 immediately notifies the user of completion of notification of the selected direction (step S368) after the start of the direction notification process (step S360). After notifying the user of completion of notification of the selected direction (step S368), the communication control circuit 210 terminates the direction notification process (step S360) and thereby terminates the full range evaluation process (step S300).

In the wireless communication system 10 of the second embodiment described above, the user can make antenna adjustment of the access point 20 based on the check result of the throughput by checking the system information notified by using the external antenna unit 300 of the access point 20. This results in improving the work efficiency of antenna adjustment of the access point 20.

Additionally, the access point 20 notifies the user of the system information showing the direction in which the antenna 380 is to be pointed, by using the external antenna unit 300, so that the user can readily make antenna adjustment of the access point 20 based on the check result of the throughput.

### C. Third Embodiment

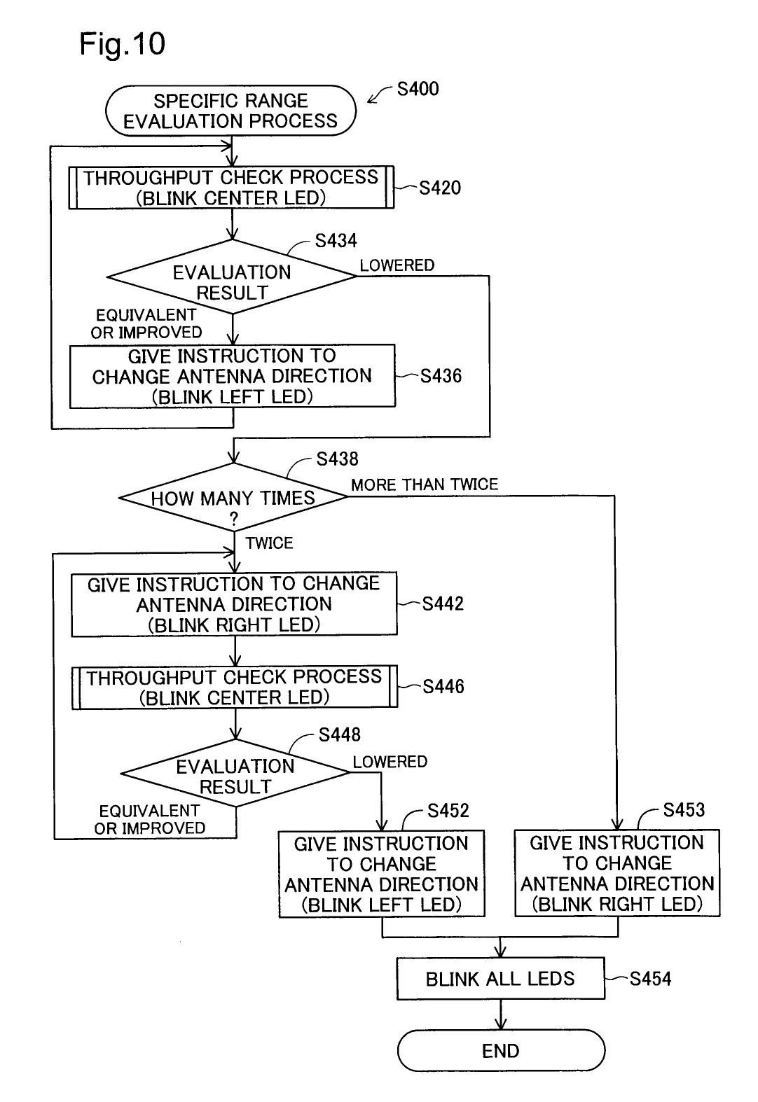

FIG. 10 is a flowchart showing a specific range evaluation process (step S400) performed by the access point 20 according to a third embodiment. The wireless communication system 10 of the third embodiment is similar to that of the first embodiment, except the specific range evaluation process (step S400) performed by the access point 20. The specific range evaluation process (step S400) is series of processing to narrow down the direction of the antenna 380 in the good communication status and notify the user of system information, which shows the direction in which the antenna 380 is to be pointed, by using the external antenna unit 300. In other words, the specific range evaluation process (step S400) checks the throughput at plural directions of the external antenna unit 300, identifies the direction in which the check result is lowered, and notifies the user of a specific direction different from the identified direction as the direction in which the external antenna unit 300 is to be pointed. In this embodiment, the communication control circuit 210 of the access point 20 starts the specific range evaluation process (step S400), in response to the user's command input received by the user interface 280.

On the start of the specific range evaluation process (step S400), the communication control circuit 210 of the access point 20 serving as the throughput check module 214 performs throughput check process (step S420). In the throughput check process (step S420), the communication control circuit 210 checks the throughput of communication with the station 50 and writes the throughput check data 222 showing the check result into the storage unit 220. The details of the throughput check process (step S420) are identical with those of the throughput check process (step S120) of the first embodiment.

After the first throughput check process (step S420), the communication control circuit 210 serving as the notification controller 216 blinks the light-emitting element 360c or the left LED and thereby gives the user instruction to rotate the direction of the antenna 380 counterclockwise by one step (30° in this embodiment) (step S436). After giving the user instruction to change the direction of the antenna 380 (step S436), the communication control circuit 210 performs the throughput check process (step S420) again.

After the second or further throughput check process (step S420), the communication control circuit 210 checks whether the check result of the throughput by the throughput check process (step S420) has been lowered by the change of the antenna direction (step S434). When the check result of the throughput indicates the equivalency or improvement, the communication control circuit 210 repeats the series of processing from giving the instruction on rotating the antenna direction (step S436). This identifies the antenna direction in which the check result of the throughput is lowered by the counterclockwise rotation.

When the check result of the throughput by the throughput check process (step S420) has been lowered (step S434), the communication control circuit 210 checks whether the throughput check process (step S420) has been performed twice or more than twice (step S438). Performing twice indicates the probable presence of the direction having the better check result of the throughput than the initial direction in the clockwise rotation, while performing more than twice indicates that the direction checked one step before the direction having the lowered check result has the better check result of the throughput.

When the throughput check process (step S420) has been performed more than twice (step S438), the communication control circuit 210 serving as the notification controller 216 blinks the light-emitting element 360a or the right LED and thereby gives instruction to rotate the direction of the antenna 380 by one step (30° in this embodiment) clockwise (step S453). The user is thereby notified of the direction checked one step before the direction having the lowered check result in the counterclockwise rotation, as the direction in which the antenna 380 is to be pointed.

When the throughput check process (step S420) has been performed twice (step S438), the communication control circuit 210 serving as the notification controller 216 blinks the light-emitting element 360a or the right LED and thereby gives instruction to rotate the direction of the antenna 380 by one step (30° in this embodiment) clockwise (step S442). The communication control circuit 210 then performs the throughput check process (step S446) in the same manner as the throughput check process (step S420) described above.

After the throughput check process (step S446), the communication control circuit 210 checks whether the check result of the throughput by the throughput check process has been lowered by the change of the antenna direction (step S448). When the check result of the throughput indicates the equivalency or improvement, the communication control circuit 210 repeats the series of processing from giving the instruction on rotating the antenna direction (step S442). This identifies the antenna direction in which the check result of the throughput is lowered by the counterclockwise rotation and indicates that the direction checked one step before the direction having the lowered check result has the better check result of the throughput.

When the check result of the throughput by the throughput check process (step S446) has been lowered (step S448), the communication control circuit 210 serving as the notification controller 216 blinks the light-emitting element 360c or the left LED and thereby gives instruction to rotate the direction of the antenna 380 by one step (30° in this embodiment) counterclockwise (step S452). The user is therefore notified of the direction checked one step before the direction having the lowered check result in the clockwise rotation, as the direction in which the antenna 380 is to be pointed.

After notifying the user of the direction in which the antenna 380 is to be pointed (step S452 or S453), the communication control circuit 210 blinks the three light-emitting elements 360a, 360b and 360c or all the LEDs and thereby notifies the user of completion of checking the throughput (step S454). The communication control circuit 210 then terminates the specific range evaluation process (step S400).

In the wireless communication system 10 of the third embodiment described above, the user can make antenna adjustment of the access point 20 based on the check result of the throughput by checking the system information notified by using the external antenna unit 300 of the access point 20. This results in improving the work efficiency of antenna adjustment of the access point 20.

Additionally, the access point 20 notifies the user of the system information showing the direction in which the antenna 380 is to be pointed, by using the external antenna unit 300, so that the user can readily make antenna adjustment of the access point 20 based on the check result of the throughput.

### D. Fourth Embodiment

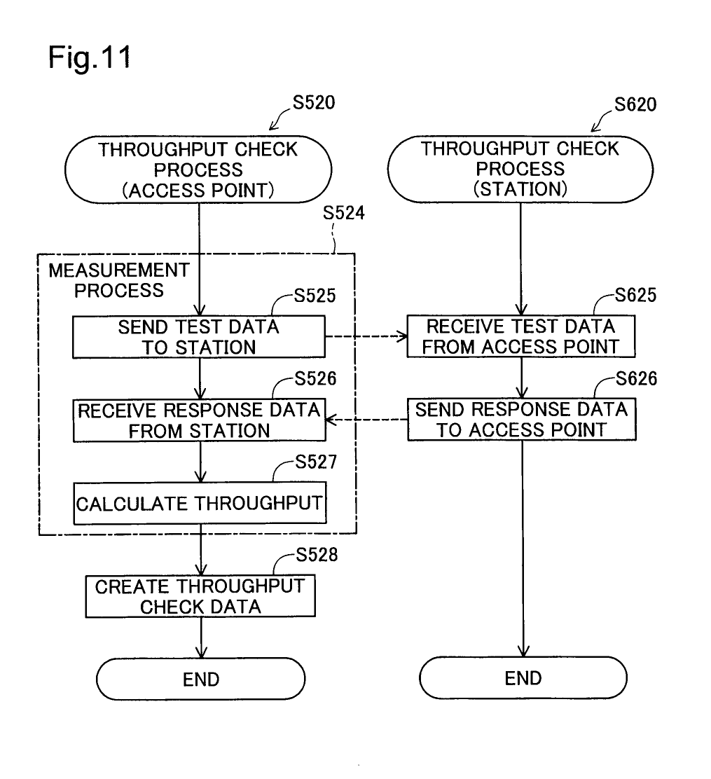

FIG. 11 is a flowchart showing throughput check process (steps S520 and S620) performed by the access point 20 and the station 50 in the wireless communication system 10 according to a fourth embodiment. The wireless communication system 10 of the fourth embodiment is similar to that of the first embodiment, except the throughput check process (steps S520 and S620) of FIG. 11 performed instead of the throughput check process (steps S120 and S220) of FIG. 8. The throughput check process (steps S520 and S620) of FIG. 11 is series of processing to check the throughput of communication between the access point 20 and the station 50 wherein the access point 20 measures the throughput, unlike the throughput check process (steps S120 and S220) of FIG. 8 wherein the station 50 measures the throughput.

On the start of the throughput check process (step S520), the communication control circuit 210 of the access point 20 serving as the throughput check module 214 performs measurement process (step S524). In the measurement process (step S524), the communication control circuit 210 measures the throughput of communication with the station 50.

More specifically, in the measurement process (step S524), the communication control circuit 210 transmits test data to the station 50 by wireless communication using the antenna 380 (step S525) and receives response data from the station 50 responding to the data transmission (step S526). The communication control circuit 210 then measures the throughput of communication with the station 50, based on the time required between transmission of the test data and reception of the response data and the data volume of the test data.

While the access point 20 is performing the measurement process (step S524), the controller 510 of the station 50 receives the test data from the access point 20 by wireless communication using the antenna 590 (step S625) and sends the response data to the access point 20 (step S626).

After the measurement process (step S524), the communication control circuit 210 of the access point 20 creates the throughput check data 222 based on the measurement result by the measurement process (step S524) and writes the created throughput check data 222 into the storage unit 220 (step S528). The communication control circuit 210 of the access point 20 then terminates the throughput check process (step S520).

In the wireless communication system 10 of the fourth embodiment described above, the user can make antenna adjustment of the access point 20 based on the check result of the throughput by checking the system information notified by using the external antenna unit 300 of the access point 20. This results in improving the work efficiency of antenna adjustment of the access point 20.

Additionally, the access point 20 performs the measurement process (step S524) to measure the throughput of communication with the station 50, thus reducing the process load of the station 50 and enabling the throughput of communication with the station 50 to be checked based on the measured values.

### E. Other Embodiments

Although the invention has been described with reference to preferred embodiments, it will be understood by those skilled in the art that various modifications may be made to the particular embodiments discussed above without departing from the scope of the invention as set forth in the accompanying claims. For example, the throughput check process (steps S520 and S620) of the fourth embodiment may be applied to the second embodiment or the third embodiment. The full range check process (step S310) of the second embodiment checks the communication status at each antenna direction in the counterclockwise rotation, but the communication status may be checked in the clockwise rotation or in any other arbitrary order. The specific range evaluation process (step S400) of the third embodiment checks the communication status at each antenna direction first in the counterclockwise rotation and subsequently in the clockwise rotation, but the communication status may be checked first in the clockwise rotation and subsequently in the counterclockwise rotation or in any other arbitrary order. In any order, the similar effects to those of the above embodiment are ensured.

The cable 310 connecting the RF physical layer chip 230 with the antenna 380 is used to enable the main unit 200 to control the notification on the external antenna unit 300 in the above embodiments, but a discrete dedicated cable from the cable 310 connecting the RF physical layer chip 230 with the antenna 380 may be used for the same purpose according to another embodiment. Only one cable 310 is used to enable the main unit 200 to control the notification on the external antenna unit 300 in the above embodiment, but plural cables 310 may be used for the same purpose according to another embodiment. In such cases, the notification of the system information may be diversified. Although the external antenna unit 300 is separate from the main unit 200 in the above embodiments, the external antenna unit 300 (antenna 380) and the main unit 200 may be integrated in one casing. In this case, for example, an integral antenna unit corresponding to the external antenna unit 300 is electrically connected with an integral main unit corresponding to the main unit 200 by means of an internal wiring in place of the coaxial cable.

Light emission of the three light-emitting elements 360a, 360b and 360c provided on the external antenna unit 300 is used for notification in the above embodiment, but one or two light-emitting elements or four or more light-emitting elements may be used for the same purpose according to other embodiments. Alternatively the user may be notified of the system information by means of sound output from a speaker. Examples of the sound from the speaker include voice-based notification of the system information, such as “optimum”, “right” or “left” and meaningless signal tone-based notification of the system information, such as short and long signal tones or different numbers of signal tones.

The user moves the external antenna unit 300 and changes the direction of the antenna 380 with the support base 320 so as to adjust the direction of the antenna 380 in the above embodiments, but the user may change the direction of the antenna 380 that is provided on the support base 320 to be rotatable in the horizontal direction, at a fixed location of the support base 320 according to another embodiment. According to still another embodiment, the antenna 380 may be provided on the support base 320 to be rotatable in the horizontal direction by means of a motor, and the motor may be driven in response to the user's input or based on the check result of the throughput to change the direction of the antenna 380, at a fixed location of the support base 320. Driving the motor based on the check result of the throughput may be implemented, for example, by driving the motor based on signals for blinking the above light-emitting elements 360a, 360b and 360c.

The external antenna unit is provided on the access point 20 in the above embodiments, but an external antenna unit may be provided on at least one of the access point 20 and the station 50 to be used for notifying the user of the system information like the above embodiments.

The throughput is checked at six different directions, 0°, 60°, 120°, 180°, 240° and 300° by rotating the antenna 380 by the angle of every 60 degrees in the above embodiment but may otherwise be checked at two different directions, for example, 0° and 180°. Checking the throughput in the latter manner also allows for improvement of the throughput and facilitates detection of the direction, in which the antenna 380 is to be pointed, for the improved throughput.

The notification is implemented by the blink pattern of the three LEDs in the above embodiments but may also be implemented by, for example, arranging plural light-emitting elements in the radial direction at every preset angle about one specific point on the external antenna unit 300 and varying the number of light emissions at the respective angles based on the check result of the throughput. The number of light emissions may be increased or may be decreased to notify the user of the adequate antenna direction. In place of the plural light-emitting elements, one light-emitting element extended in the radial direction may be arranged at every preset angle and vary the emission intensity to implement the notification. The emission intensity may be increased or may be decreased to notify the user of the adequate antenna direction. These configurations enable the user to be intuitionally notified of the adequate antenna direction.

The external antenna unit 300 including the plural antennas 380 is used in the above embodiments, but the plural antennas 380 may discretely form external antenna units. In other words, the plural antennas may be configured to be independently pointed in intended directions. In this configuration, for example, light-emitting elements may be provided on each of the antennas to notify the user of system information based on the result of the above throughput check process performed for each antenna.

While the invention has been described with reference to exemplary embodiments thereof, it is to be understood that the invention is not limited to the disclosed embodiments or constructions. On the contrary, the invention is intended to cover various modifications and equivalent embodiments. In addition, while the various elements of the disclosed invention are shown in various combinations and configurations, which are exemplary, other combinations and configurations, including more, less or only a single element, are also within the spirit and scope of the invention.

1. A wireless communication device that wirelessly communicates by Multi Input Multi Output (MIMO) with another wireless communication device, comprising:
a main unit including a communication control circuit, controls wireless communication with the another wireless communication device;
an antenna unit including an antenna that sends and receives communication signals to and from the another wireless communication device, the antenna unit electrically connectable with the main unit.
a throughput check module that checks a throughput of communication with the another wireless communication device; and
a notification module that notifies a user of system information by using the antenna unit, the system information based on a check result of the throughput check module.

2. The wireless communication device according to claim 1, wherein the system information indicates at least one of a level of communication status with the another wireless communication device and a direction in which the antenna is to be pointed.

3. The wireless communication device according to claim 1, wherein
the main unit is electrically connectable with the antenna unit via a coaxial cable, and
the notification module includes:
an applying circuit that applies DC power based on the system information to a first wiring to which the applying circuit is electrically connected, the first wiring making an electrical connection between the communication control circuit and the coaxial cable;
a first DC cutoff circuit that cuts for cutting supply of DC power to the communication control circuit, the first DC cutoff circuit being provided between the communication control circuit and the applying circuit on the first wiring;
a generating circuit that generates at least one of light and sound according to DC power applied to a second wiring to which the generating circuit is electrically connected, the second wiring making an electrical connection between the coaxial cable and the antenna; and
a second DC cutoff circuit that cuts supply of DC power to the antenna, the second DC cutoff circuit provided between the generating circuit and the antenna on the second wiring.

4. The wireless communication device according to claim 1, wherein the throughput check module includes at least one of:
a measurement module that measures a throughput of communication with the another wireless communication device; and
an obtaining module that obtains a measurement result of a throughput measured at the another wireless communication device from the another wireless communication device.

5. The wireless communication device according to claim 1, wherein
the throughput check module checks the throughput with respect to a plurality of directions of the antenna, and
the notification module notifies the user of a direction in which the antenna is to be pointed, by using the antenna unit, based on a check result of the throughput check module.

6. The wireless communication device according to claim 5, wherein
the plurality of directions of the antenna correspond to directions of the antenna rotated by a preset angle a plurality of times, and
the notification module notifies the user of a rotating direction and a number of rotations to the direction in which the antenna is to be pointed, by using the antenna unit.

7. The wireless communication device according to claim 1, wherein
the throughput check module checks the throughput with respect to a plurality of directions of the antenna and identifies a direction of a lowering check result obtained by checking the throughput, and
the notification module notifies the user of a direction different from the identified direction.

8. A wireless communication system comprising a wireless access point and a wireless station, wherein
at least one of the wireless access point and the wireless station is a wireless communication device that wirelessly communicates by a Multi Input Multi Output (MIMO) with another wireless communication device, and
the wireless communication device includes:
a main unit that includes a communication control circuit, that controls wireless communication with the another wireless communication device;
an antenna unit including an antenna that sends and receives communication signals to and from the another wireless communication device, the antenna unit being electrically connectable with the main unit;
a throughput check module that checks a throughput of communication with the another wireless communication device; and
a notification module that notifies a user of system information by using the antenna unit, the system information based on a check result of the throughput check module.

9. An information notifying method of notifying a user of information by a wireless communication device that wirelessly communicates by Multi Input Multi Output (MIMO) with another wireless communication device, comprising:
checking a throughput of communication with the another wireless communication device; and
notifying the user of system information based on a check result of the throughput, by using an antenna unit electrically connected via a cable with a main unit that includes a communication control circuit that controls wireless communication with the another wireless communication device, and the antenna unit includes an antenna that sends and receives communication signals to and from the another wireless communication device.

10. The information notifying method according to claim 9, wherein the system information indicates at least one of a level of communication status with the another wireless communication device and a direction in which the antenna is to be pointed.

11. The information notifying method according to claim 9, wherein the checking a throughput includes at least one of:
measuring a throughput of communication with the another wireless communication device; and
obtaining a measurement result of a throughput measured at the another wireless communication device from the another wireless communication device.

12. The information notifying method according to claim 9, wherein
the checking a throughput checks the throughput with regard to a plurality of directions of the antenna, and
the notifying system information notifies the user of a direction in which the antenna is pointed, based on a check result of the throughput, by using the antenna unit.

13. The information notifying method according to claim 12, wherein
the plurality of directions of the antenna are directions of the antenna rotated by a preset angle a plurality of times, and
the notifying system information notifies the user of a rotating direction and a number of rotations to the direction in which the antenna is to be pointed, by using the antenna unit.

14. The information notifying method according to claim 9, wherein
the checking a throughput checks a throughput with regard to a plurality of directions of the antenna, to identify a direction of a lowering check result obtained by checking the throughput, and
the notifying system information notifies the user of a direction different from the identified direction.
